(19) United States
(12) Patent Application Publication
(10) Pub. No.: US 2025/0086901 A1
(43) Pub. Date: Mar. 13, 2025

(54) ANOMALY DETECTION FOR GUIDED PROCEDURES IN AN AUGMENTED REALITY ENVIRONMENT

(71) Applicant: Squint, Inc., San Jose, CA (US)

(72) Inventors: Devin Bhushan, San Jose, CA (US); Dylan Conway, Denver, CO (US); Jim Zhu, Seattle, WA (US); Benjamin Weaver, Mountain View, CA (US)

(21) Appl. No.: 18/463,255

(22) Filed: Sep. 7, 2023

(51) Int. Cl. G06T 19/00; G06Q 10/0639

(52) U.S. Cl. CPC G06T 19/006; G06Q 10/06393

(57) ABSTRACT

An augmented reality (AR) system enables creation and viewing of AR content for sharing information relating to a physical environment. The AR content may be organized into procedures comprising a set of structured steps presented in an AR view of an environment. An application may track progress and provide various feedback as each step is performed. An analytics engine may track events of the AR device including user interactions and state data of the AR device (e.g., detected motion state, detected image-based features, etc.) during the course of executing a procedure. The analytics engine may perform various analytics such as detecting anomalies and generating various performance metrics, safety-based metrics, aggregations, and visual representations of statistical data relating to performance of the AR-guided procedures.

### BACKGROUND

Various organizations utilize standard operating procedures (SOPs) to help workers carry out operations in a manner that aims to achieve efficiency, quality control, and uniformity of performance. Traditionally, such operating procedures are documented in user manuals or instructional videos, or may be communicated only by word of mouth. Producing these traditional documents can be very laborious and performance of the procedures remain error-prone based on errors in the documentation itself or errors resulting from following complex instructions. Moreover, organizations currently do not have access to robust mechanisms that enable tracking of various procedures, measuring operator performance, detecting anomalies, and gaining insights to improve operational efficiencies.

### BRIEF DESCRIPTION OF THE DRAWINGS

Figure (FIG. 1 is an example embodiment of an AR view of a real-world environment with virtual objects.

FIG. 2 is an example embodiment of an AR view associated with a procedure.

FIG. 3 is an example embodiment of an AR view associated with a specific step of a procedure.

FIG. 4 is an example embodiment of a set of AR user interface screens associated with creating virtual objects.

FIG. 5 is an example embodiment of an AR system.

FIG. 6 is an example embodiment of an AR device associated with an AR system.

FIG. 7 is an example embodiment of a client-side AR application associated with an AR system.

FIG. 8 is an example embodiment of a process for detecting anomalies associated with a guided procedure facilitated by an AR system.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. Wherever practicable, similar or like reference numbers may be used in the figures and may indicate similar or like functionality.

An AR system enables creation and viewing of AR content for sharing information relating to a physical environment. The AR content may be organized into procedures comprising a set of structured steps presented in an AR view of an environment. The AR view may include various virtual objects such as text, images, animations, videos, or other content to guide a user through completing a procedure in a step-by-step manner. An application may furthermore track progress and provide various feedback as each step is performed. An analytics engine may track events of the AR device including user interactions and state data of the AR device (e.g., detected motion state, detected image-based features, etc.) during the course of executing a procedure. The analytics engine may perform various analytics such as detecting anomalies and generating various performance metrics, safety-based metrics, aggregations, and visual representations of statistical data. The analytics engine may provide immediate feedback relating to detected anomalies as notifications displayed on the AR device or sent to a separate administrator device. The analytics may furthermore invoke an action associated with equipment relating to the procedure, such as initiating a calibration, a reset, a power shutdown, or other action. Event data may furthermore be aggregated over time and from multiple devices to generate various insights into performance differences between different users, facilities, or enterprises, to identify procedures or steps that can be improved, or to generate various recommendations for improving overall operations.

FIG. 1 illustrates an AR device 110 showing an example AR view 100 of a manufacturing environment that may include various complex machinery. In this example, the AR view 100 shows several virtual objects 102, 104, 106 displayed at different specific positions in the three-dimensional physical space. The virtual objects 102, 104, 106 may correspond to different types of content. For example, a first virtual object 102 is positioned near a central location of a machine and when selected via the touchscreen of the AR device 110, may initiate a start of a “lockout tagout procedure” associated with the machine. Another virtual object 104 provides a simple informational note associated with a particular button of the machine, indicating that the “button here is sticky.” Another virtual object 106 provides a safety warning to “keep fingers out of pinch point.”

In this example, the virtual objects 102, 104, 106 are pinned to the relevant locations in the physical space such that they appear to the viewer as stationary with respect to the physical environment even when the AR device 110 changes position or orientation. In practice, this effect involve moving the position, orientation, and/or scale of the virtual objects 102, 104, 106 in the displayed image to compensate for movement of the AR device 110. For example, if the AR device 110 pans to the left, the virtual objects 102, 104, 106 may be displayed towards the right side of the displayed AR view 100 and vice versa, such that the objects 102, 104, 106 appear stable relative to the environment.

In some embodiments, the AR system may be employed to enable a user to explore a physical environment in a free form manner. The virtual objects may be displayed in the AR viewer when the field of view of the AR device overlaps with the location of a virtual object.

In other usage scenarios, the AR system enables creation and viewing of procedures associated with a physical environment. Here, a procedure may comprise a sequence of tasks set forth in a step-by-step manner. For each step of a procedure, the AR system may present an AR-based user interface that enables the viewer to view the physical environment supplemented with one or more virtual objects that provide instructional guidance for facilitating the procedure step. The virtual objects may include pinned virtual objects presented proximate to relevant real-world objects associated with the procedure step and/or may include floating virtual objects that are unfixed from a particular position. In some situations, the virtual objects may provide navigational instructions to guide a user to a particular location in the physical environment associated with a procedure step. The virtual objects may furthermore point to, or otherwise visually indicate, a particular object or region of interest in the physical environment associated with the procedure step. Steps of a procedure may be presented sequentially, with the interface advancing upon completion of each step. The AR system may furthermore present feedback relating to execution of the procedure as the user performs the various steps.

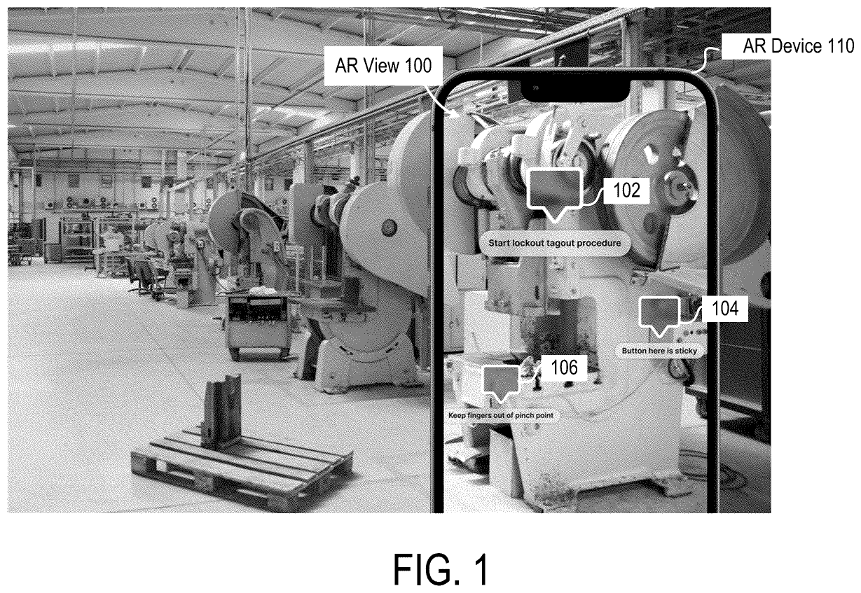

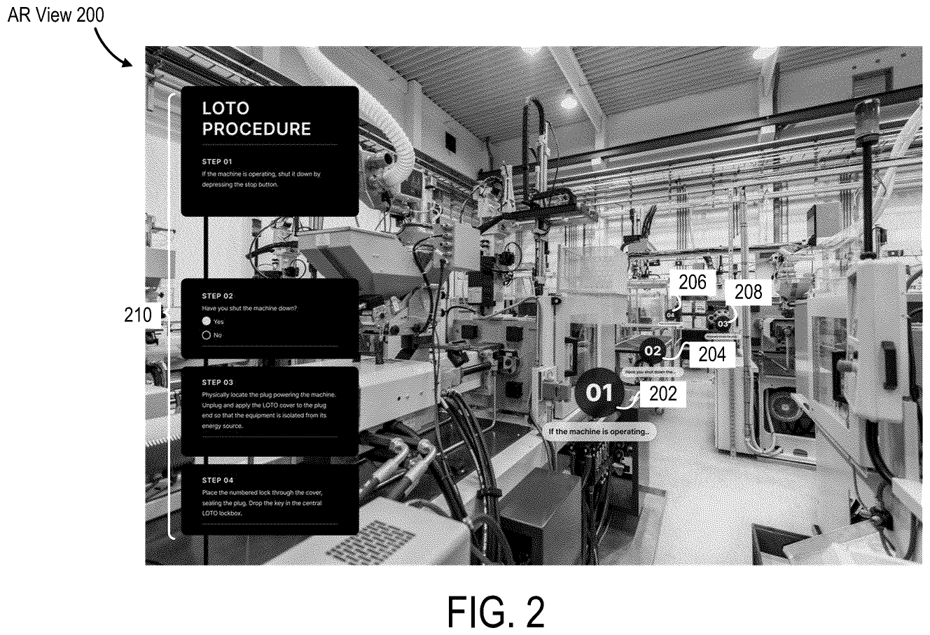

FIG. 2 illustrates an example AR view 200 associated with a procedure to be performed in a manufacturing environment. Here, the AR view 200 includes several pinned virtual objects 202, 204, 206, 208 that correspond to different sequential steps of a procedure to be performed using different components of the manufacturing machinery. The pinned virtual objects 202, 204, 206, 208 are displayed such that they appear to be fixed in the physical space proximate to the relevant component regardless of the position and orientation of the AR viewing device in the physical space. The AR view 200 also includes several floating virtual objects 210 that provide various general information about the procedure and individual steps. These virtual objects 210 may remain positioned on a left side of the viewing interface unfixed to any specific position in the physical space.

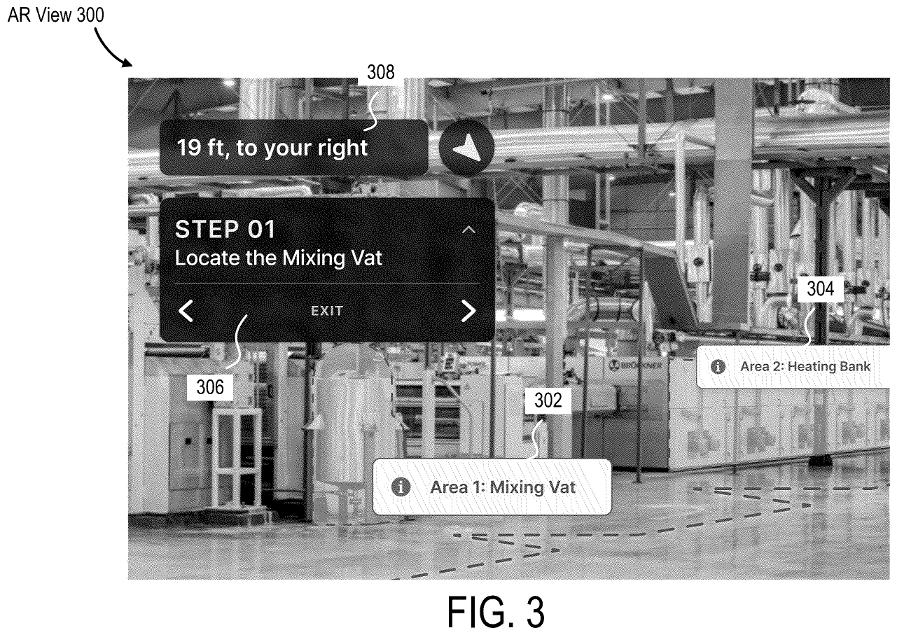

FIG. 3 illustrates another example AR view 300 relating to a specific step of a procedure (e.g., Step 1—“locate the mixing vat”). In this example, virtual objects 302, 304 are utilized to designate relevant areas of a factory (e.g., “Area 1: Mixing Vat”, “Area 2: Heating Bank.”). The virtual objects 302, 304 include both labels and dashed lines outlining the relevant area. Furthermore, these objects 302, 304 include an information link (“i” icon) that may provide access to additional linked information in the form of text, multimedia, or other digital content. The AR view 300 also includes a virtual object 306 describing the current step to be performed and a virtual object 308 for navigation instructions associated with the step. For example, the navigation instructions direct the viewer to the relevant position in the physical space “19 ft, to your right”, and also includes a navigation arrow showing the specific direction to the desired user position for performing the step of the procedure.

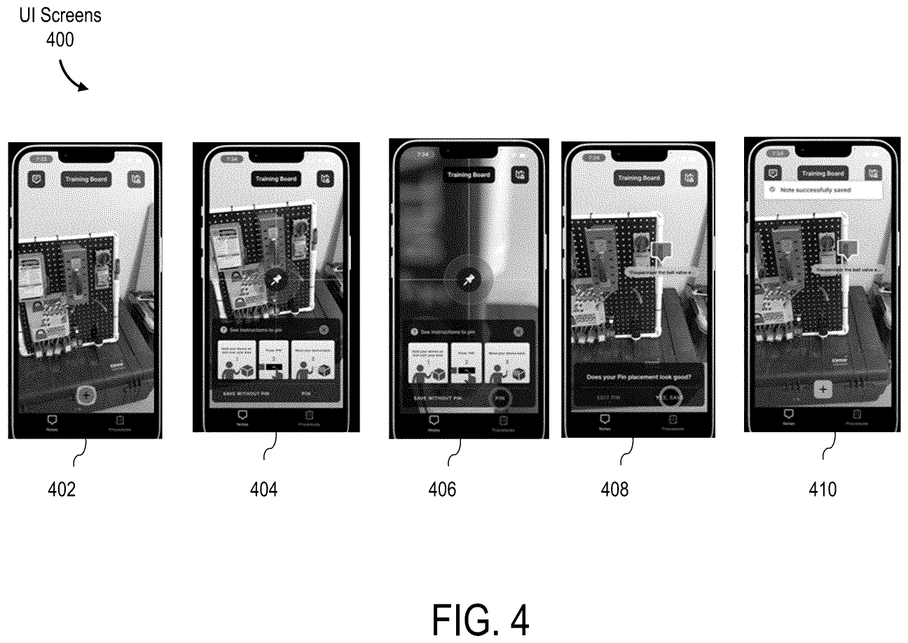

FIG. 4 illustrates a set of user interface screens 400 associated with another example use of the described AR system. In this example, the AR system enables creation of pinned virtual content that may be incorporated into a procedure or into a freeform AR experience. For example, a first interface screen 402 shows a real-time view of a physical environment including a training board associated with one or more tasks. A second interface screen 404 provides on-screen control elements and instructions for pinning a virtual object to a location on the training board. In this example, a “pin” icon is shown in the center of the screen to help the user visualize where the pinned virtual object will be placed. In interface screen 406, the user selects a location to pin the virtual object. In interface screen 408, a confirmation dialog is shown allowing the user to confirm that the pinned virtual object is correctly positioned. Interface screen 410 shows the result of the pinned virtual object being successfully placed.

An AR system enabling the techniques of FIGS. 1-4 may be employed for various instructional purposes. For example, the AR system may be employed to guide a user through processes such as a manufacturing process, a diagnostic process, a repair process, a safety check process, a calibration process, or other relevant processes. In addition to usage scenarios in manufacturing environments like those shown in FIGS. 1-4, the AR system may be similarly utilized in other environments. For example, in an office environment, the AR system may be used to provide procedures or information relating to the use of devices such as copying machines, a coffee maker, or a printer. In a construction environment, the AR system may be employed to precisely indicate construction tasks (e.g., where to put a post), operate construction equipment, etc. The AR system can further be deployed for training purposes associated with various tasks such as performing aviation procedures within a cockpit, training medical personnel to carry out a medical process, assisting an appliance repairperson through a particular repair or diagnostic procedure, etc.

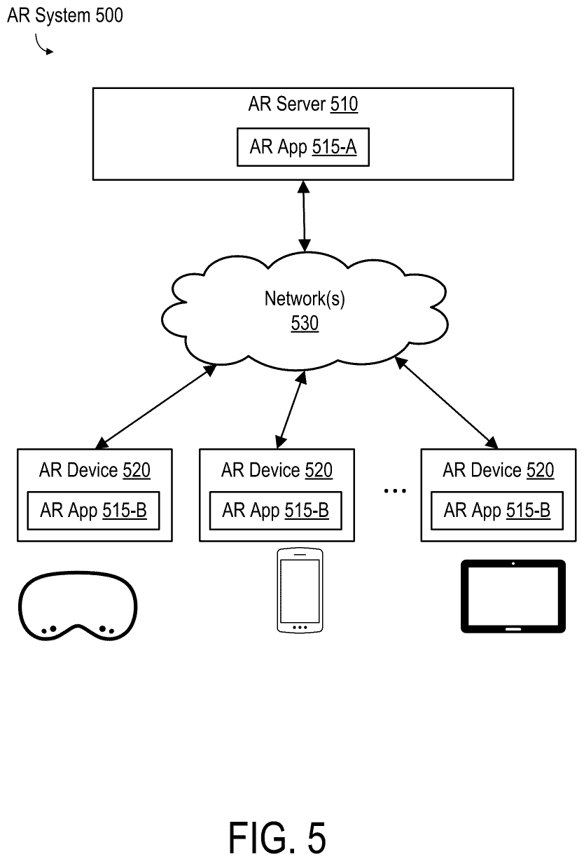

FIG. 5 is a block diagram of an AR system 500 for enabling any of the above-described techniques according to one embodiment. The AR system 500 includes a network 530, an AR server 510, and one or more AR devices 520. In alternative configurations, different and/or additional components may be included in the AR system 500.

The AR device 520 comprises a computing device for processing and presenting AR content. In various embodiments, the AR device 520 may comprise, for example, a mobile device, a tablet, a laptop computer, a head-mounted display device, a smart goggle or glasses device, a smart contact lens (or pair of lenses), or other device capable of displaying AR content. The AR device 520 may furthermore include various input and output devices that enable a user to input commands, data, or other information, and to view and/or interact with various output information. The AR device 520 may furthermore include network connectivity via a wired and/or wireless connection to enable communications with the AR server 510 or other network-connected devices. The AR device 520 may include one or more processors and one or more non-transitory computer-readable storage mediums that store instructions executable by the one or more processors for carrying out the functions attributed herein to the AR device 520.

The AR server 510 comprises one or more computing devices for facilitating an AR experience in conjunction with one or more AR devices 520. The AR server 510 may be implemented as one or more traditional physical servers and/or one or more virtual machines. The AR server 510 may comprise one or more on-site processing and/or storage devices coupled to one or more AR devices 520 via a private network, or may comprise cloud processing and storage technologies, or a combination thereof. For example, in a cloud-based implementation, the AR server 510 may include multiple distributed computing and storage devices managed by a cloud service provider. The AR server 510 may include an aggregation of multiple servers responsible for different functions and may include various physical and/or virtual servers managed and/or operated by different entities. In various implementations, the AR server 510 may comprise one or more processors and one or more non-transitory computer-readable storage mediums that store instructions executable by the one or more processors for carrying out the functions attributed to the AR server 510 herein.

The AR server 510 may execute a server-side AR application 515-A and the one or more AR devices 520 may respectively execute a client-side AR application 515-B. The server-side AR application 515-A and client-side AR application 515-B may operate in coordination with each other to facilitate various functions of the AR system 500 described herein. In various implementations, certain functions may be executed entirely on the AR server 510, entirely on the AR device 520, or jointly between the AR server 510 and the AR device 520. For example, functions and/or data that are computationally and/or storage intensive or functions that may be shared between a large number of AR devices 520 may benefit from being executed and/or stored by the server-side AR application 515-A. Functions that involve localized data and/or preferably are not subject to latency, bandwidth, and/or other connectivity constraints may benefit from execution on by the client-side AR application 515-B. In an embodiment, the AR server 510 may enable the AR device 520 to download the client-side AR application 515-B and/or may push out periodic updates. As used herein, reference to the AR application 515 may refer to an application that can be executed by the AR device 520 in some embodiments, the AR server 510 in other embodiments, or jointly by the AR device 520 and the AR server 510 in further embodiments.

The one or more networks 530 provides communication pathways the AR server 510 and the one or more AR devices 520. The network(s) 530 may include one or more local area networks (LANs) and/or one or more wide area networks (WANs) including the Internet. Connections via the one or more networks 530 may involve one or more wireless communication technologies such as satellite, WiFi, Bluetooth, or cellular connections, and/or one or more wired communication technologies such as Ethernet, universal serial bus (USB), etc. The one or more networks 530 may furthermore be implemented using various network devices that facilitate such connections such as routers, switches, modems, firewalls, or other network architecture.

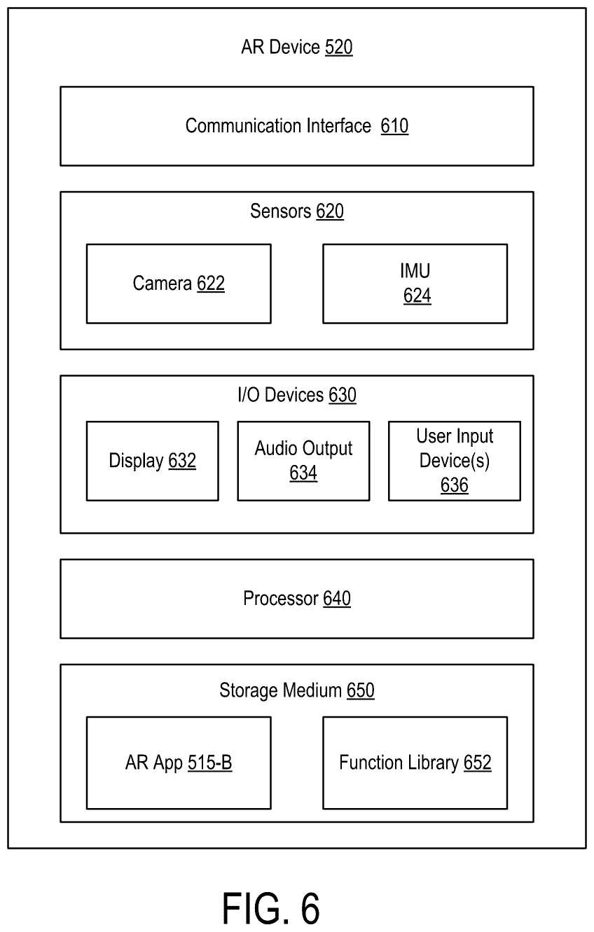

FIG. 6 is a block diagram illustrating an embodiment of an AR device 520. In the illustrated embodiment, the AR device 520 comprises a communication interface 610, sensors 620, I/O devices 630, one or more processors 640, and a storage medium 650. Alternative embodiments may include additional or different components.

The communication interface 610 facilitates communication between the AR device 520 and the one or more networks 530. The communication interface 610 may comprise a wireless interface such as a WiFi interface, a cellular interface (e.g., 3G, 4G, 5G, etc.) a Bluetooth interface, or other wireless interface. In other implementations, the communication interface 610 may include one or more wired communication interfaces such as, for example, a Universal Serial Bus (USB) interface, a Lightning interface, or other communication interface. The communication interface 610 may furthermore include a combination of different interfaces.

The sensors 620 detect various conditions associated with the operating environment of the AR device 520. In an example implementation, the sensors 620 may include at least one camera 622 and an inertial measurement unit (IMU) 624. The camera 622 captures digital images and/or video of the physical environment. In various embodiments, the camera 622 may include a conventional digital camera (typical of those integrated in mobile devices and tablets), a stereoscopic or other multi-view camera, a lidar camera or other depth-sensing camera, a radar camera, or other type of camera or combination thereof. The IMU 624 senses motion of the AR device 520 via one or more motion sensing devices such as an accelerometer and/or gyroscope. Examples of motion data that may be directly obtained or derived from the IMU 624 include, for example, position, velocity, acceleration, orientation, angular velocity, angular acceleration, or other position and/or motion parameters. In some embodiments, the IMU 624 may include various additional sensors such as a temperature sensor, magnetometer, or other sensors that may aid in calibrating and/or filtering the IMU data to improve accuracy of sensor data.

The sensors 620 may optionally include other sensors (not shown) for detecting various conditions such as, for example, a location sensor (e.g., a global positioning system), audio sensor, a temperature sensor, humidity sensor, pressure sensors, or other sensors.

The input/output devices 630 include various devices for receiving inputs and generating outputs for the AR device 520. In an embodiment, the input/output devices may include at least a display 632, an audio output device 634, and one or more user input devices 636. The display device 632 presents images or video content associated with operation of the AR device 520. The display device 632 may comprise, for example, an LED display panel, an LCD display panel, or other type of display. In head-mounted devices, the display device 632 may comprise a stereoscopic display that presents different images to the left eye and right eye to create the appearance of three-dimensional content. The display device 632 may furthermore present digital content that combines rendered graphics depicting virtual objects and/or environments with content captured from a camera 622 to enable an augmented reality presentation with virtual objects overlaid on a physical environment.

The audio output device 634 may include one or more integrated speakers or a port for connecting one or more external speakers to play audio associated with the presented digital content.

The user input device 636 may comprise, for example, a touchscreen interface, a microphone for capturing voice commands or voice data input, a keyboard, a mouse, a trackpad, a joystick, a gesture recognition system (which may rely on input from the camera 322 and/or IMU 324), a biometric sensor, or other input device that enables user interaction with the client-side AR application 515-B.

In further embodiments, the input/output devices 630 may include additional output devices for providing feedback to the user such as, for example, a haptic feedback device and one or more light emitting diodes (LEDs).

The storage medium 650 (e.g., a non-transitory computer-readable storage medium) stores various data and instructions executable by the processor 640 for carrying out functions attributed to the AR device 520 described herein. In an embodiment, the storage medium 650 stores the client-side AR application 515-B and a function library 652.

The function library 652 may include various functions that can be employed by the client-side AR application 515-B. For example, the function library 652 may comprise various operating system (OS) functions or standard development kit (SDK) functions that are accessible to the client-side AR application 515-B via an application programming interface (API). The function library 652 may include functions for processing sensor data from the sensor 620 such as, for example, performing filtering, transformations, aggregations, image and/or video processing, or other processing of raw sensor data. The client-side AR application 515-B may utilize the function library 652 for performing tasks such as depth estimation, feature generation/detection, object detection/recognition, location and/or orientation sensing, or other tasks associated with operation of the client-side AR application 515-B. The function library 652 may further facilitate various functions associated with rendering AR content such as performing blending operations, physics simulations, image stabilization, or other functions.

The function library 652 may include a set of functions that may be employed to track a state of the AR device 520, which may include a pose (position and orientation) and/or motion parameters (e.g., velocity, acceleration, etc.). The functions may utilize IMU data from the IMU 624 and/or visual information from the camera 622. In example embodiment, tracking may be performed using visual inertial odometry (VIO) techniques. State data may include position, orientation, or other state parameters associated with VIO-based tracking (e.g., scale). State data may be stored as transformation matrices describing changes between states. For example, state data may be described as 4×4 transformation matrices in a standardized representation employed by function library 652 native to common mobile device operating systems.

The function library 652 may furthermore include functions for identifying and tracking feature points representing visual features of a physical space. This feature point detection may further aid tracking. Visual features may include edge information, contour information, color information, contrast information, or other visual information that enables the AR device 520 to estimate its pose relative to a physical space. Selected visual features may be limited to those that are robust to changes in viewing angle, distance, lighting conditions, camera-specific parameters, or other variables. These features enable detection and matching of features depicted in different images even when the images are captured under different conditions, with different devices, and/or from different perspectives.

In an embodiment, specific tracking functions may be implemented via calls to the function library 652 in a manner that is not necessarily transparent to the client-side AR application 515-B. The client-side AR application 515-B may access a limited set of relevant tracking data generated via the function library 652 such as state data associated with feature points and real-time or historic state information for the tracked AR device 520 relative to the global origin for the tracking session.

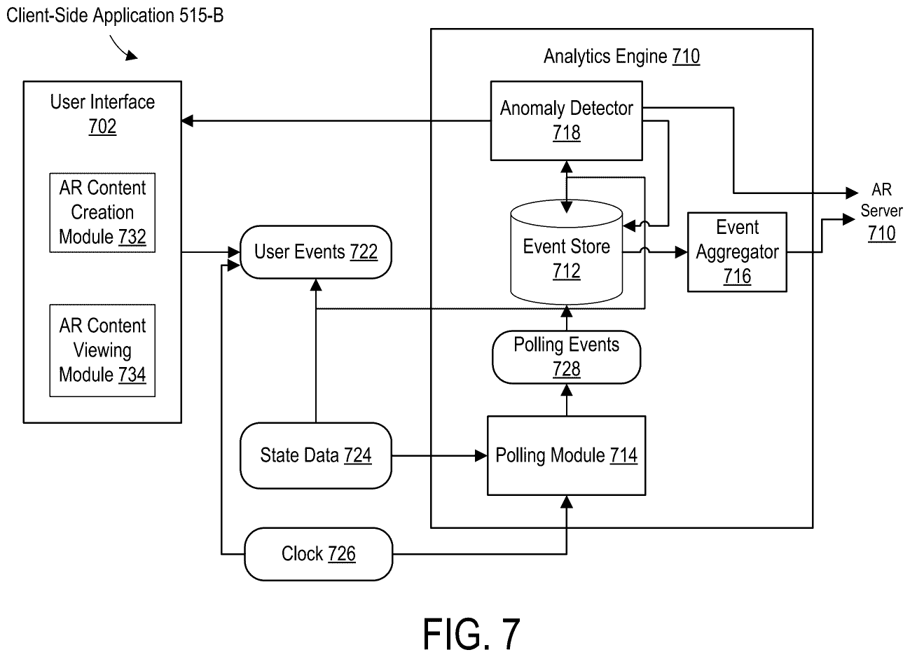

FIG. 7 illustrates an example embodiment of a client-side AR application 515-B. The client-side application 515-B includes a user interface 702 and an analytics engine 710, which includes an event store 712, a polling module 714, an event aggregator 716, and an anomaly detector 718. Other embodiments may include different or additional modules.

The user interface 702 include various user interface elements to facilitate user interactions with the AR system 500. In an embodiment, the user interface 702 includes an AR content creation module 732 and an AR content viewing module 734. The AR content creation module 732 facilitates the creation of AR content. The created AR content may include various virtual objects that may be pinned in specific environments, procedures comprising structured sequences of steps relating to a specific environment (which may be guided by pinned and/or floating virtual objects), or other AR content. In the course of creating AR content, the AR content creation module 732 may generate a map of an environment that includes a structured set of data describing a localized physical space. The AR content creation module 732 may furthermore enable pinning of virtual objects to a selected position in the physical space relative to the mapped environment. Pinning may be initiated via user interface controls such as graphical elements, gesture inputs, voice controls, or other input mechanisms. The AR content creation module 732 may furthermore enable input of content associated with a pinned object, such as structured or unstructured text, one or more images, one or more videos, one or more animations, an interactive form, a link to multimedia or other data, or other information. The virtual object may be represented by the associated content itself (e.g., the entered text or image) and/or an interactive virtual icon associated with the content. For example, the virtual object may take the form of a sticky note graphic that may include various text or images, and may be displayed in the AR environment in a manner that appears analogous to a real-life sticky note placed on a surface. The AR content creation module 732 may utilize various state tracking data to track a location of the AR device 520 relative to the mapped environment and identify locations for placing virtual objects.

The AR content creation module 732 may furthermore facilitate creation of procedures that may be associated with one or more environment maps. As described above, a procedure may include a sequence of steps to be performed in the physical space. Each step may be presented in an AR view that may include various virtual objects (including pinned virtual objects and/or floating virtual objects) to facilitate performance of the procedure. For example, the AR content may provide navigation directions to guide the user to the appropriate position and orientation for performing a step. The AR content may furthermore include pinned objects associated with a machine, equipment, or other element relevant to a procedure and provide guidance associated with completing a particular step (e.g., “push this button 3 times, then turn this lever 90 degrees”). The AR content creation module 732 may provide various user interface tools to enable a creator to create, modify, and store procedures. A created procedure may include various criteria for confirming when each step is complete, which may include manually entered confirmations, automatically detected verifications, or a combination thereof. For example, a procedure step may include instructions for a user to take a picture of an object when the step is complete, and an image analysis may be performed to verify that the step is properly completed. In another example, a user may be prompted to enter a readout from equipment associated with the procedure to enable verification of step completion.

The AR content viewing module 734 facilitates viewing and interacting with procedures and other AR content. The AR content viewing module 734 renders an AR view of the physical environment based on the virtual objects (and corresponding pinned positions) and may update the display based on a tracked state of the AR device 520. For example, the AR content viewing module 734 determines when a position of a created virtual object is within the field of view of the AR device 520 and renders the virtual object in an AR view at a corresponding position (i.e., such that it appears to the viewer that the virtual object is present in the physical environment at the specified position). The AR content viewing module 734 may display content such as pinned virtual objects, navigation instructions to guide the user to a particular location, or other information generally relevant to the physical space.

The AR content viewing module 734 may facilitate presentation of AR views associated with carrying out a stored procedure. For each step, the AR content viewing module 734 may load relevant virtual objects associated with the procedure step and render them in the AR view of the AR device 520 as the AR device 520 moves through the physical space. In various embodiments, the AR content viewing module 734 may provide user interface tools to enable the user to advance forward or backward between steps, to mark steps as complete, to provide feedback or other notes with respect to particular steps, or perform other actions relevant to the procedure.

During the course of interactions relating to creating and/or viewing AR content, the user interface 702 may obtain various user inputs such as selection of user interface controls, text inputs, voice inputs, or other inputs. These inputs may be captured as user events 722 and stored at least temporarily to the event store 712. The user events 722 may include a timestamp (e.g., from the clock 726) indicative of timing of the user input and various descriptors indicating the mode of capture (e.g., control selection, text input, voice input, etc.), the input content (e.g., identifier for a control being selected, content of text or voice input, etc.), state data 724 associated with the AR device 520, or other data descriptors for the user event. The state data 724 may be obtained from the function library 652 as described above and may include tracked state information of the AR device 520 and surrounding environment such as a position, velocity, acceleration, orientation, angular velocity, angular acceleration, detected feature points, a detected environment map, environment point cloud and scene meshing data, camera frame data, various statistical data, or other state information. The user event data 722 may furthermore include application-level actions associated with the user input that is independent of the specific input mechanism. For example, in the context of a procedure, event data may include a “begin procedure” event, an “advance to next step” event, a “go back to previous step” event, a “photo upload” event, a “request for help” event, a “mark complete” event, etc. The event store 712 may organize the received user events 722 in a database format (e.g., a set of values corresponding to different data fields) that may be indexable, filterable, and searchable.

The polling module 714 performs polling of the state data 724 based on the clock 726 to capture polling events for storing to the event store 712. A polling event may include a timestamp and values for the various state variables describing the state of the AR device 520. The polling module 714 may be configured to capture state events on a periodic basis independently of user events 722.

The anomaly detector 718 detects anomalies associated with execution of procedures. Anomalies may be detected based on application of a preconfigured set of detection rules or based on various classification techniques. Rule-based detection may involve applying a set of preconfigured detection rules to event data in the event store 712 and determining when one or more detection criteria are met. For example, a detection rule may operate to detect an anomaly when a step of a procedure exceeds a predefined threshold time, when the step is being performed with the AR device 520 positioned outside of a spatial area attributed to the step, or when a step is being performed when feature points associated with the step are not within the field of view of the AR device 520. In other examples, a detection rule may detect when the AR device 520 is dropped (or the user falls) by detecting an acceleration of the AR device 520 corresponding to gravitational acceleration that occurs over a predefined distance or time period. In further example, a detection rule may detect, based on image analysis, when equipment associated with the procedure visually indicates a status inconsistent with the step.

The anomaly detector 718 may furthermore detect anomalies by applying a classification model trained to detect sequences of events that vary with statistical significance from historical event sequences associated with the procedure. Here, the anomaly detector 718 may identify when performance of the procedure is atypical, without necessarily relying on a specific rule for detecting the anomalous behavior.

The anomaly detector 718 may furthermore predict future anomalies based on a set of observed events even if the anomalous action has not yet actually occurred. Here, a machine learning model could be trained on historical event data to predict the occurrences of anomalous events based on observed time-series event data.

In some embodiments, the anomaly detector 718 may select one or more rules or models to apply depending on the procedure being performed. Here, rules or models for detecting anomalies may be configurable together with creation of a procedure (or step) using the AR content creation module 732. Alternatively, the anomaly detector 718 may apply preconfigured rules and/or models that can be universally applied to any created procedures.

Examples of detected anomalies may include, for example, an indication that a step of a procedure was done incorrectly (or is predicted to be done incorrectly), an indication of an action to prevent or remediate an incorrect step, an indication that a step or a procedure has taken more than a predefined threshold length of time, an indication that a step or a procedure has taken less than a predefined threshold length of time, and indication that a step was performed (or is predicted to be performed) in an incorrect spatial location in the physical environment, an indication that a step was performed (or is predicted to be performed) in a known dangerous area of the physical environment, an indication that a step was performed (or is predicted to be performed) while the AR device 520 is oriented in the wrong direction, an indication that an accident may have occurred during a step, an indication that the AR device 520 is moving above a threshold speed during a step, or an indication that images captured by the AR device 520 are outside of a predefined brightness range (e.g., too dim or too bright).

The anomaly detector 718 may store detected anomalies as anomaly events in the event store 712. Each anomaly event may include a descriptor or identifier describing the anomaly together with a timestamp and/or state data 724. Furthermore, the anomaly detector 718 may generate real-time feedback to the user interface 702 indicative of detected anomalies. The feedback may cause the user interface to display a notification on the user interface 702 describing the detected anomaly. Furthermore, feedback may cause automated actions in the user interface 702 such as disabling an action to proceed to a subsequent step of a procedure, causing the interface 702 to return to a previous step of a procedure, causing the user interface 702 to initiate a sub-procedure or different procedure intended to remedy or mitigate the anomaly, etc.

In further embodiments, the anomaly detector 718 may output detected anomalies to the AR server 510. The AR server 510 may then send a notification to an external administrator device to alert an administrator to the detected anomaly. The AR server 510 may furthermore control actions of an external machine or equipment associated with the procedure being performed in response to detecting an anomaly. For example, when an anomaly is detected in relation to a procedure for servicing factory equipment, the AR server 510 may cause the equipment to automatically initiate a remedial action such as a calibration process, a shutdown, a reset, or initiating a safety action.

The event aggregator 716 aggregates events from the event store 712 to derive various statistical data or other derived indicators that may be output to the AR server 510. Aggregated events may relate to a count, average, duration, or other filtered or combined values associated with events over the course of a procedure. Aggregated data may relate to detected anomalies (described further below), various performance data, safety assessment data, or other data derived from the events. Examples of performance data may include, for example, a time taken to complete a procedure, an efficiency measure describing efficiency of movement through the procedure, a length of time spent in different areas of the factory floor, etc. Safety assessment data may include information such as an identification of a high-risk behavior, a recommend training based on performed actions, etc. In other embodiments, individual events may be sent to the AR server 510 without necessarily performing aggregation on the AR device 520.

The AR server 510 may store aggregated events received from individual AR devices 520. Furthermore, the AR server 510 may further aggregate and analyze events received from multiple AR devices 520 over a historic period to generate various analytical data. The analytical data may be queried, filtered, sorted, combined according to different combining functions, or otherwise manipulated to develop various insights into the performances of various procedures. Here, the collection of events may be sliced in different ways to generate analytical data relating to a particular user of an AR device 520, a particular facility or enterprise (e.g., a factory), a particular procedure, etc. The AR server 510 may provide an analytics dashboard that enables access to analytical data, which may be presented in the form of graphs, charts, tables, or other visual data representations. The analytical data may provide insights such as average lengths of time to complete a procedure; counts of times a procedure is performed; frequency of anomalies by user, by facility, or by procedure; counts or frequencies of different types of anomalies observed; overall safety performance metrics associated with a user, a facility, or an enterprise, etc. The AR server 510 could furthermore generate recommendations to improve created procedures. For example, the AR server 510 may recognize when a particular step is executed incorrectly at a significant rate, and generate a recommendation to clarify instructions for that step. Furthermore, the AR server 510 may recognize that a particular individual is abnormally slow or has a high rate of errors in performance of procedures, and may generate a recommendation to provide additional training to that individual.

In various alternative implementations, various modules 702, 712, 714, 716, 718 or functions thereof may instead be executed on the server-side AR application 515-B. Here, the client-side AR application 515-B may generate function calls to the server-side AR application 515-A in association with a particular operation. The server-side AR application 515-A may then perform various processing and return results to the client-side AR application 515-B.

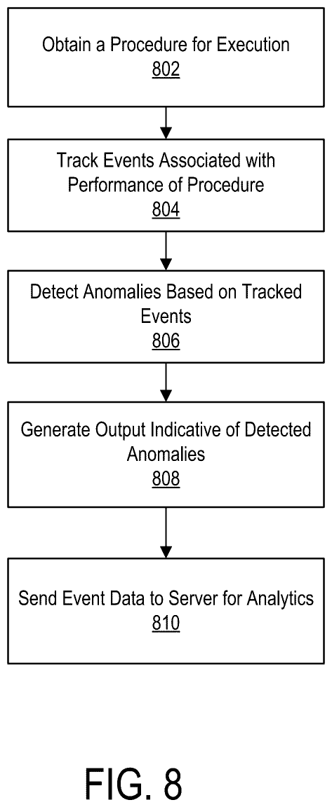

FIG. 8 illustrates an example embodiment of a process for detecting anomalies associated with performance of procedures guided by an augmented reality system 500. The AR device 520 obtains 802 a procedure for performing with AR-based guidance. The AR device 520 tracks 804 a sequence of events associated with carrying out the procedure including user events and polling events. The AR device 520 detects 806 one or more anomalies in the sequence of events associated with carrying out the procedure. For example, anomalies may be detected based on application of anomaly detection rules, based on a classification model trained to detect statistically significant deviations in performance of a procedure relative to historical performances, or based on a predictive model trained to predict an occurrence of anomalous behavior. The AR device 520 generates 808 one or more outputs indicative of the detected one or more anomalies. For example, an AR device 520 may generate a notification in a user interface, send a notification to an administrative device, and/or invoke an automated action such as shutting down equipment, performing a reset, performing a recalibration, etc. The AR device 520 may furthermore send 810 aggregated event data (which may include detected anomalies) to the AR server 510. The AR server 510 may then combine the event data with historical event data from different AR devices 520 to generate various analytics, which may relate to performance data aggregated for different users, different facilities, different enterprises or other groupings. The AR server 510 may provide an administrative interface to enable the aggregated data to be queried, filtered, or combined in different ways to generate various metrics or visual representations (e.g., graphs, charts, tables, etc.) The AR server 510 may furthermore generate recommendations for improving procedures based on the aggregated data.

The figures and the description relate to embodiments by way of illustration only. Alternative embodiments of the structures and methods disclosed herein will be readily recognized as viable alternatives that may be employed without departing from the principles of the embodiments.

Upon reading this disclosure, those of skill in the art will still appreciate additional alternative structural and functional designs for the disclosed embodiments from the principles herein. Thus, while particular embodiments and applications have been illustrated and described, the disclosed embodiments are not limited to the precise construction and components disclosed herein. Various modifications, changes and variations, which will be apparent to those skilled in the art, may be made in the arrangement, operation and details of the disclosed embodiments herein without departing from the scope.

1. A method for detecting anomalies associated with performance of procedures guided by an augmented reality system, the method comprising:
obtaining a procedure for performing in association with an augmented reality device, the procedure comprising steps to be performed, wherein at least a subset of the steps are associated with one or more virtual objects presented in an augmented reality view of the augmented reality device that provide guidance associated with the steps;
tracking, by the augmented reality device, a sequence of events associated with carrying out the procedure, the sequence of events including tracked user interactions with the augmented reality device and tracked state data derived from image data and motion data captured by the augmented reality device;
detecting one or more anomalies in the sequence of events associated with carrying out the procedure; and
generating one or more outputs indicative of the one or more anomalies.

2. The method of claim 1, wherein generating the one or more outputs further includes sending aggregated event data to an augmented reality server, wherein the augmented reality server combines the aggregated event data with event data from multiple other augmented reality devices over a historical time period to generate analytical data.

3. The method of claim 2, wherein the analytical data represents an aggregate performance metric associated with the procedure, a user, a facility, or an enterprise.

4. The method of claim 1, wherein the one or more virtual objects comprises a pinned virtual object associated with a step, the pinned virtual object presented at a fixed physical position in an augmented reality view of an environment.

5. The method of claim 1, wherein the one or more virtual objects includes a navigation instruction to guide positioning or orientation of the augmented reality device relative to the augmented reality view of an environment.

6. The method of claim 1, wherein the tracked user interactions comprises selection of a control element of the augmented reality device presented in the augmented reality view of an environment in association with performance of a step.

7. The method of claim 1, wherein the tracked state data includes at least one of: a position, a velocity, an acceleration, an orientation, an angular velocity, and an angular acceleration associated with the augmented reality device, a set of feature points detected from image analysis of images captured by the augmented reality device, and a detected environment map detected from the images captured by the augmented reality device.

8. The method of claim 1, wherein tracking the sequence of events comprises at least one of:
capturing one or more user events triggered in response to a user input; and
capturing one or more polling events triggered based on a polling mechanism.

9. The method of claim 1, wherein detecting the one or more anomalies includes:
applying a set of anomaly detection rules associated with the procedure to the sequence of events.

10. The method of claim 1, wherein detecting the one or more anomalies includes:
applying a classification model associated with the procedure to the sequence of events to detect when the sequence deviates with statistical significance from historical event sequences associated with procedure.

11. The method of claim 1, wherein detecting the one or more anomalies includes:
applying a predictive model to predict an occurrence of an anomaly based on the sequence of events.

12. The method of claim 1, wherein generating the one or more outputs comprises:
generating a notification in a user interface of the augmented reality device indicative of the one or more anomalies.

13. The method of claim 1, wherein generating the one or more outputs comprises:
sending a notification indicative of the one or more anomalies to an augmented reality server to an administrative client.

14. The method of claim 1, wherein generating the one or more outputs comprises:
generating a notification to an augmented reality server coupled to the augmented reality device to enable the augmented reality server to control an action of a machine associated with the procedure, the action comprising at least one of: a calibration action, a reset action, a shutdown action, and a safety action.

15. A non-transitory computer-readable storage medium storing instructions for detecting anomalies associated with performance of procedures guided by an augmented reality system, the instructions when executed by a processor causing the processor to perform steps including:
obtaining a procedure for performing in association with an augmented reality device, the procedure comprising steps to be performed, wherein at least a subset of the steps are associated with one or more virtual objects presented in an augmented reality view of the augmented reality device that provide guidance associated with the steps;
tracking, by the augmented reality device, a sequence of events associated with carrying out the procedure, the sequence of events including tracked user interactions with the augmented reality device and tracked state data derived from image data and motion data captured by the augmented reality device;
detecting one or more anomalies in the sequence of events associated with carrying out the procedure; and
generating one or more outputs indicative of the one or more anomalies.

16. The non-transitory computer-readable storage medium of claim 15, wherein generating the one or more outputs further includes sending aggregated event data to an augmented reality server, wherein the augmented reality server combines the aggregated event data with event data from multiple other augmented reality devices over a historical time period to generate analytical data.

17. The non-transitory computer-readable storage medium of claim 16, wherein the analytical data represents an aggregate performance metric associated with the procedure, a user, a facility, or an enterprise.

18. An augmented reality device comprising:
one or more cameras for capturing image data;
one or more motion sensors for capturing motion data;
one or more processors; and
a non-transitory computer-readable storage medium storing instructions for detecting anomalies associated with performance of procedures guided by an augmented reality system, the instructions when executed by the one or more processors causing the one or more processors to perform steps including:
obtaining a procedure for performing in association with an augmented reality device, the procedure comprising steps to be performed, wherein at least a subset of the steps are associated with one or more virtual objects presented in an augmented reality view of the augmented reality device that provide guidance associated with the steps;
tracking, by the augmented reality device, a sequence of events associated with carrying out the procedure, the sequence of events including tracked user interactions with the augmented reality device and tracked state data derived from the image data and the motion data;
detecting one or more anomalies in the sequence of events associated with carrying out the procedure; and
generating one or more outputs indicative of the one or more anomalies.

19. The augmented reality device of claim 18, wherein generating the one or more outputs further includes sending aggregated event data to an augmented reality server, wherein the augmented reality server combines the aggregated event data with event data from multiple other augmented reality devices over a historical time period to generate analytical data.

20. The augmented reality device of claim 19, wherein the analytical data represents an aggregate performance metric associated with the procedure, a user, a facility, or an enterprise.
